(19) United States
(12) Patent Application Publication
(10) Pub. No.: US 2026/0230559 A1
(43) Pub. Date: Aug. 6, 2026

(54) VERIFYING A CALLING PARTY

(71) Applicant: Telefonaktiebolaget LM Ericsson (publ), Stockholm (SE)

(72) Inventors: Konstantinos STRATOULIAS, Patras (GR); Leena Marjatta MATTILA, Turku (FI)

(21) Appl. No.: 19/152,292

(22) PCT Filed: Mar. 29, 2023
(86) PCT No.: PCT/EP2023/058169

§ 371 Date: Jul. 30, 2025

(30) Foreign Application Priority Data
Feb. 1, 2023 (GR) 20230100080

(51) Int. Cl. H04M 3/436; H04L 9/40; H04M 3/42

(52) U.S. Cl. CPC H04M 3/436; H04L 63/0838; H04M 3/42059

(57) ABSTRACT

Methods and apparatus are provided. In some examples, a method of verifying a calling party is provided. The method includes receiving, on a first communication channel, a call request, the call request identifying a calling party, and sending, to the calling party on a second communication channel different from the first communication channel, a verification request to verify that the calling party is an originator of the call request, the verification request identifying a first value. If a reply to the verification request is received from the calling party indicating that the calling party is the originator of the call request, and the reply identifies a second value based on the first value, it is determined that the calling party is the originator of the call request.

### TECHNICAL FIELD

Example embodiments of this disclosure relate to verifying a calling party, such as a calling party of a voice or video call.

### BACKGROUND

Voice calls and video calls may originate from several different sources, such as fixed (landline) phones, mobile phones, private branch exchanges (PBXs), Voice over Internet Protocol (VolP), and others. Usually, one of two signaling protocols may be used for communication between the network functions and interconnections, and these are Signaling System 7 (SS7) and Session Initiation Protocol (SIP). This signaling was or is transported over various technologies, such as time division multiplexing (TDM), Asynchronous Transfer Mode (ATM), and Internet Protocol (IP).

Native SS7, which is used in Public Switched Telephone Networks (PSTNs) and in 2G and 3G Public Land Mobile Networks (PLMNs), does not provide any authentication capability of the calling party. If transported Internet Protocol Security (IPsec) tunnels are used, this may allow the authentication of interconnections and thus of the calling party. SIP, which is used in 4G and 5G PLMNs, can be transported over secure transport protocols (i.e. Transport Layer Security, TLS), which only allows authentication of peer Session Initiation Protocol (SIP) User Agents (SUAs) but not the originator of the call.

This native lack in the signaling protocols that control the calls has led to the emergence of caller ID spoofing. A user may spoof caller ID information using VolP, an Internet calling card service, open source telephone exchange software, or a number of other spoofing techniques. A bridge device may implement such spoofing techniques by calling a receiving device and providing the spoofed caller ID information to the receiving device, calling a sending device using the real caller ID information (e.g., the real phone number), and bridging the calls. The impact of illegitimate uses of caller ID spoofing presents unique challenges for the industry in addressing consumer concerns with fraudulent calls. The consumers must be protected against calls from parties that impersonate trusted persons, companies and agencies and can lead the consumer to share information that he or she should be sharing only with the person, company, or agency he or she is supposed to be talking to.

A solution that can be effective for all scenarios is challenging. The Alliance for Telecommunications Industry Solutions (ATIS), “Calling Party Spoofing Mechanisms and Mitigation Techniques”, April 2016, https://access.atis.org/apps/group_public/download.php/28385/ATIS-I-0000051.pdf, outlines practical mitigation techniques being developed and emphasizes that caller ID spoofing is not a static problem that can be solved with a single solution.

The IETF STIR Working Group (draft-ietf-stir-rfc4474bis) has for some time been working on a mechanism that would allow individual phone numbers to be signed at the origin, and verified at the termination (e.g. the called party). The Federal Communications Commission (FCC) has mandated all telecom providers in the US to implement STIR/SHAKEN, an industry-driven solution based on digital signatures and applicable only to SIP calls.

In addition to STIR/SHAKEN, other solutions have been proposed and developed. For example, SEISMIC is based on transferring off-path call metadata for verifying the authenticity of the calling party. Mobile networks can check the plausibility of the originating international call by checking the location of the calling party using SS7 messages.

### SUMMARY

Examples of this disclosure may have certain advantages. For example, embodiments of this disclosure may allow a calling party to be verified, regardless of the underlying technology or channel over which the call or a request for the call is made, e.g. SS7 or SIP, or other technologies.

One aspect of the present disclosure provides a method of verifying a calling party. The method comprises receiving, on a first communication channel, a call request, the call request identifying a calling party, and sending, to the calling party on a second communication channel different from the first communication channel, a verification request to verify that the calling party is an originator of the call request, the verification request identifying a first value. The method also comprises, if a reply to the verification request is received from the calling party indicating that the calling party is the originator of the call request, and the reply identifies a second value based on the first value, determining that the calling party is the originator of the call request.

Another aspect of the present disclosure provides a method of verifying a calling party. The method comprises receiving, on a second communication channel different from a first communication channel for calls and/or requests for calls, a verification request to verify that a calling party is an originator of the call request, the verification request identifying a first value, and, if the calling party is the originator of the call request, sending a reply to a sender of the verification request indicating that the calling party is the originator of the call request, the reply identifying a second value based on the first value.

A further aspect of the present disclosure provides apparatus for verifying a calling party. The apparatus comprises a processor and a memory. The memory contains instructions executable by the processor such that the apparatus is operable to receive, on a first communication channel, a call request, the call request identifying a calling party, send, to the calling party on a second communication channel different from the first communication channel, a verification request to verify that the calling party is an originator of the call request, the verification request identifying a first value, and, if a reply to the verification request is received from the calling party indicating that the calling party is the originator of the call request, and the reply identifies a second value based on the first value, determine that the calling party is the originator of the call request.

A still further aspect of the present disclosure provides apparatus for verifying a calling party. The apparatus comprises a processor and a memory. The memory contains instructions executable by the processor such that the apparatus is operable to receive, on a second communication channel different from a first communication channel for calls and/or requests for calls, a verification request to verify that a calling party is an originator of the call request, the verification request identifying a first value, and, if the calling party is the originator of the call request, send a reply to a sender of the verification request indicating that the calling party is the originator of the call request, the reply identifying a second value based on the first value.

Another aspect of the present disclosure provides apparatus for verifying a calling party. The apparatus is configured to receive, on a first communication channel, a call request, the call request identifying a calling party, send, to the calling party on a second communication channel different from the first communication channel, a verification request to verify that the calling party is an originator of the call request, the verification request identifying a first value, and, if a reply to the verification request is received from the calling party indicating that the calling party is the originator of the call request, and the reply identifies a second value based on the first value, determine that the calling party is the originator of the call request.

Another aspect of the present disclosure provides apparatus for verifying a calling party. The apparatus is configured to receive, on a second communication channel different from a first communication channel for calls and/or requests for calls, a verification request that a calling party is an originator of the call request, the verification request identifying a first value, and, if the calling party is the originator of the call request, send a reply to a sender of the verification request indicating that the calling party is the originator of the call request, the reply identifying a second value based on the first value.

A further aspect of the present disclosure provides a method in a system for verifying a calling party. The system comprises a calling party and a called party. The method comprises receiving, at the called party on a first communication channel, a call request, the call request identifying the calling party; sending, by the called party to the calling party on a second communication channel different from the first communication channel, a verification request to verify that the calling party is an originator of the call request, the verification request identifying a first value; receiving, at the calling party on the second communication channel, the verification request; if the calling party is the originator of the call request, sending, by the calling party, a reply to the verification request to the called party indicating that the calling party is the originator of the call request, the reply identifying a second value based on the first value; and if a reply to the verification request is received from the calling party indicating that the calling party is the originator of the call request, and the reply identifies a second value based on the first value, determining, by the called party, that the calling party is the originator of the call request.

A still further aspect of the present disclosure provides a system for verifying a calling party. The system comprises a calling party and a called party. The system is configured to receive, at the called party on a first communication channel, a call request, the call request identifying the calling party; send, by the called party to the calling party on a second communication channel different from the first communication channel, a verification request to verify that the calling party is an originator of the call request, the verification request identifying a first value; receive, at the calling party on the second communication channel, the verification request; if the calling party is the originator of the call request, send, by the calling party, a reply to the verification request to the called party indicating that the calling party is the originator of the call request, the reply identifying a second value based on the first value; and if a reply to the verification request is received from the calling party indicating that the calling party is the originator of the call request, and the reply identifies a second value based on the first value, determine, by the called party, that the calling party is the originator of the call request.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 is a flow chart of an example of a method verifying a calling party;

FIG. 2 is a flow chart of another example of a method verifying a calling party;

FIG. 3 shows an example of a system in which examples of this disclosure may be implemented;

FIG. 4 shows an example of architectural design of a commercial push notification service;

FIG. 5 shows another example of a system in which examples of this disclosure may be implemented;

FIG. 6 shows an example of communications in an example method of verifying a calling party;

FIG. 7 shows another example of communications in an example method of verifying a calling party;

FIG. 8 shows another example of communications in an example method of verifying a calling party;

FIG. 9 shows an example of communications in an example method of verifying a calling party where the verification fails;

FIG. 10 shows another example of communications in an example method of verifying a calling party where the verification fails;

FIG. 11 is a schematic of an example of an apparatus for verifying a calling party; and

FIG. 12 is a schematic of an example of another apparatus for verifying a calling party.

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g. analog and/or discrete logic gates interconnected to perform a specialized function, Application Specific Integrated Circuits (ASICs), Programmable Logic Arrays (PLAs), etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g. digital or analogue) circuitry including but not limited to application specific integrated circuit(s) (ASIC) and/or field programmable gate array(s) (FPGA(s)), and (where appropriate) state machines capable of performing such functions.

Except from STIR/SHAKEN, referred to above, there is no proposed solution that allows to verify that the caller ID really belongs to the person/company that initiated a call, i.e. that the calling party (which may be associated with the caller ID) is the originator of the call. Many mitigations are trying to block already known malicious caller IDs, e.g. via black listing, white listing, or rejection of anonymous calls. However, these do not verify that the party initiating a call (the originator of the call) is the legitimate owner of the caller ID used in the call, and hence that the calling party (identified by the caller ID) is the originator of the call. The mitigation techniques described in the ATIS document referred to above rely to some extent on the accuracy of the calling party information, and this is what a spoofing attack relies on.

STIR/SHAKEN has two main limitations. First, it requires a new public key infrastructure (PKI), but scaling up this PKI for the global telecom industry is difficult. Implementing STIR/SHAKEN within one country is not sufficient, as many spoofed caller ID calls originate from abroad. Second, it only works with the SIP (VOIP) system, leaving the traditional SS7 (landline and cellular) systems unprotected. SEISMIC and other “off-path” solutions require a central authority (registry or distributed ledger) for maintaining call metadata. The SS7-based solutions apply only to calling line identification (CLI) spoofing cases where the calling subscriber is a mobile subscriber, and don't work if the spoofed subscriber is roaming abroad.

Embodiments of this disclosure may provide solutions to these or other problems. For example, some examples of this disclosure provide methods of verifying a calling party, i.e. that the caller ID or calling party identified in a call or call request is the originator of the call, and is not another party spoofing the caller ID. Examples of this disclosure may provide for example a channel, different from the channel over which the call takes place or is initiated, over which the calling party (the party identified in the call or request for the call) can be verified. For example, a verification value may be sent over the different channel to the calling party, and if the calling party originated the call, a reply may be sent including the verification value (or a value based on or derived from the verification value) to indicate that the calling party is the genuine originator of the call.

Some examples propose a system, referred to as caller ID OTP Verification (CIOV), which uses a One-Time-Password (OTP) to verify to the called party that the call really comes from the presented caller ID, i.e. that the calling party associated with the caller ID is the originator of the call. OTP is used by various enterprises and bank institutes to authenticate users using two-factor authentication. Two factor authentication may authenticate a user for example by confirming that the user's device registered with the authentication system—typically a mobile device—is in fact in the user's possession.

In a particular example, a calling party is referred to as A (Alice) and a called party is referred to as B (Bob). When B (Bob) receives a call or a request for a call that identifies A (Alice) as the calling party, in some examples, an application of Bob's device generates an One-Time-Password and sends it out-of-band to A (Alice). When the application on the device of Alice receives the OTP, it sends it back to Bob, or a different value derived from the OTP. Once the application on Bob's device receives the OTP (or value derived from it) and confirms that it is the OTP it generated and sent to Alice, it may be determined or concluded that Alice was the originator of the call. Thus, in some examples, appropriate action may be taken, e.g. Bob may receive a notification that the caller ID has been verified, the call may be accepted or allowed to continue, etc.

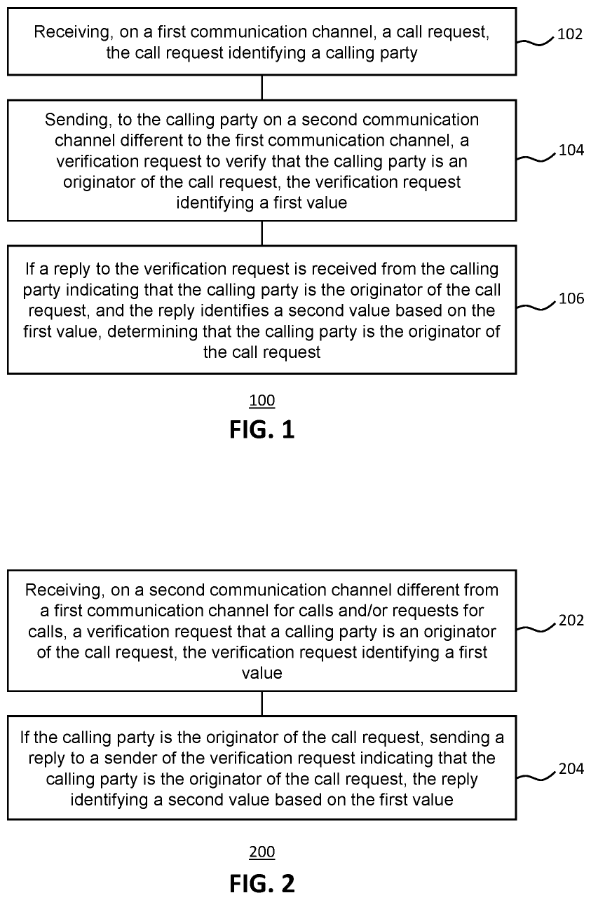

FIG. 1 is a flow chart of an example of a method 100 of verifying a calling party. In some examples, the method 100 may be performed by the called party that receives a call request. The calling party, i.e. the party that is identified in the call request, may or may not be the party that originated the call, and hence the method 100 may for example verify whether or not the apparent calling party is the originator of the call request.

The method 100 comprises, in step 102, receiving, on a first communication channel, a call request, the call request identifying a calling party. The call request may be a request for a voice call or a video call for example. The request may identify the calling party by including for example a caller ID. The request may be for example a Signaling System No. 7 (SS7) message or a Session Initiation Protocol (SIP) message.

In some examples, the first communication channel may be a channel for calls and/or call requests. In some examples, a “channel” may include a route for communications through one or more particular networks or network nodes, or additionally or alternatively a protocol for communications (e.g. SS7, SIP etc).
Step 104 of the method 100 comprises sending, to the calling party on a second communication channel different from the first communication channel, a verification request to verify that the calling party is an originator of the call request, the verification request identifying a first value. In some examples, the first value (e.g. the verification value referred to above) may be randomly or pseudorandomly generated. The first value may be an OTP for example. The verification request may in some examples identify the calling party, a subscriber ID or caller ID of the calling party, the called party and/or the subscriber ID or caller ID of the called party.

The second channel may comprise for example one or more of: a network different from a network of the first channel, the internet, a channel for push notifications, a channel for an Instant Messaging Service (IMS), and/or a channel for a Short Messaging Service (SMS). For example, the verification request may be a SMS message sent to the calling party, where the SMS message contains the first value. The verification request may in some examples be a request to send a push notification to the calling party, a Short Messaging Service (SMS) message; and/or an Instant Messaging Service (IMS) message. Where the verification request is a request to send a push notification to the calling party, this may be sent to an application server for example.

In step 106 of the method 100, if a reply to the verification request is received from the calling party indicating that the calling party is the originator of the call request, and the reply identifies a second value based on the first value, it may be determined or concluded that the calling party is the originator of the call request. This is because the calling party has responded with the second value. If the call request was spoofed by a third party, then the third party is not aware of the first value or the second value, as the verification request is sent to the calling party instead of the originator of the call (though these are the same party in the case of a genuine call from the calling party). The second value may be the same as the first value or may be based on or derived from the first value. For example, the calling party may modify the first value in a manner known to the called party to derive the second value, such that the second value may also be derived by the called party and compared to the second value in the reply to the verification request.

The reply to the verification request may in some examples be received in step 106 on the second channel or a third channel different from the second channel. The reply may be for example a push notification, a Short Messaging Service (SMS) message, and/or an Instant Messaging Service (IMS) message. Where the reply is a push notification, this may be received from a push notification server for example.

The method may in some examples, on determining that the calling party is the originator of the call, allow the call request (e.g. by allowing it to be accepted, by accepting it, or forwarding it to a device used by the called party), and/or sending or displaying to a called party for the call a notification that the calling party is the originator of the call request. Thus for example the user may be informed that the called party has been verified and is hence trustworthy, or is otherwise the originator of the call request.

In some examples, the method 100 may comprise determining or concluding that the calling party is not or may not be the originator of the call request if a timer started on receiving the call request times out (and a reply including the second value is not received from the calling party in that time). Alternatively, for example, the method 100 may comprise determining or concluding that the calling party is not or may not be the originator of the call request if the reply from the calling party does not identify the first value or the second value (and hence may be spoofed), or if a reply is received from the calling party indicating that the calling party is not the originator of the call request, which reply the calling party may send in some examples if it is not the originator.

On determining that the calling party is not or may not be the originator of the call request, in some examples, the method 100 may comprise performing appropriate actions. These may include, for example, rejecting or blocking the call request, terminating the call (if the call has already started), and/or sending or displaying to a called party for the call a notification that the calling party is not or may not be the originator of the call request. The latter may allow the user for example to terminate the call themselves or to avoid disclosing personal information to a third party.

The method 100 may in some examples be performed by a device associated with a called party of the call request. Alternatively, in some examples, the method 100 may be performed by a network node in a network to which the device associated with the called party is connected. For example, the network may be a cellular or mobile network to which the called party's device is connected or to which the called party is a subscriber.

FIG. 2 is a flow chart of an example of a method 200 of verifying a calling party. In some examples, the method 200 may be performed by a calling party (e.g. a party associated with a caller ID), or the calling party's device. In some examples, the method 200 is performed by the calling party that may or may not have originated a call to a called party, whereas the method 100 may be performed by the called party that receives a call request.

The method 200 comprises, in step 202, receiving, on a second communication channel different from a first communication channel for calls and/or requests for calls, a verification request that a calling party is an originator of the call request, the verification request identifying a first value. The call request may be for example a voice or video call, and may be for example a Signalling System No. 7 (SS7) message or a Session Initiation Protocol (SIP) message. The verification request may in some examples identify the calling party, a subscriber ID or caller ID of the calling party, the called party and/or the subscriber ID or caller ID of the called party.

The method 200 also comprises, in step 204, if the calling party is the originator of the call request, sending a reply to a sender of the verification request indicating that the calling party is the originator of the call request, the reply identifying a second value based on the first value.

As for the method 100, the first value may be for example a randomly or pseudorandomly generated value, and/or comprises a One Time Password (OTP). The second value is equal to the first value or may be different, such as derived from the first value.

The reply may be sent for example on the second channel or a third channel different from the first channel in step 204.

The second channel may comprise in some examples one or more of a network different from a network of the first channel, the internet, a channel for push notifications, a channel for an Instant Messaging Service (IMS), and a channel for a Short Messaging Service (SMS). The verification request may for example comprise one or more of a push notification (e.g. from a push notification server), a SMS message and/or an IMS message. The reply may in some examples comprise the reply comprises one or more of a request (e.g. to an application server) to send a push notification to the sender of the verification request, a SMS message and/or an IMS message.

In some examples, if the calling party is not the originator of the call request, a reply may be sent to the sender of the verification request indicating that the source device is not the originator of the call request. The sender of the verification request may be, for example, the called party of the call request, a device associated with the called party, or a network node in a network to which the device associated with the called party of the call request is connected. Alternatively, for example, if the calling party is not the originator of the call request, the calling party may instead ignore the verification request.

Advantages of embodiments of this disclosure may include one or more of the following. For example, the caller ID may be verified on a second channel, e.g. out of band, providing a separate verification channel discrete from the call signaling channel which might be compromised from the attacker that spoofs the caller ID. This out of band channel can in some examples be secured by using a secure transport layer. Another advantage is for example that the verification process may be initiated by the terminating side, and the verification request is routed based on the caller ID, allowing to address the actual owner of the caller ID. In some examples, the caller ID verification service is independent from the service provider network, allowing it to be used by any subscription or network. However, service providers may in some examples choose to integrate embodiments of this disclosure and offer it as an added value service to their subscribers. Enterprises may in some examples choose to deploy a server where all enterprise mobile subscriptions are registered, authorize the applications or devices of their employees. This may for example prevent attempts for corporate espionage. When it comes to users, the advantage of example embodiments is that it enables the called party to check first if the caller ID can be verified, and if it is, feel confident that this is not a spoofed call. Depending on the content of the call, the called party can decide how to react to the calling party's requests. For instance, if the calling party is a bank, the called party might choose to hang up if the caller ID cannot be verified. Alternatively, in some examples, the user may not even be presented with unverified calls.

Particular example embodiments will now be described for illustration purposes.

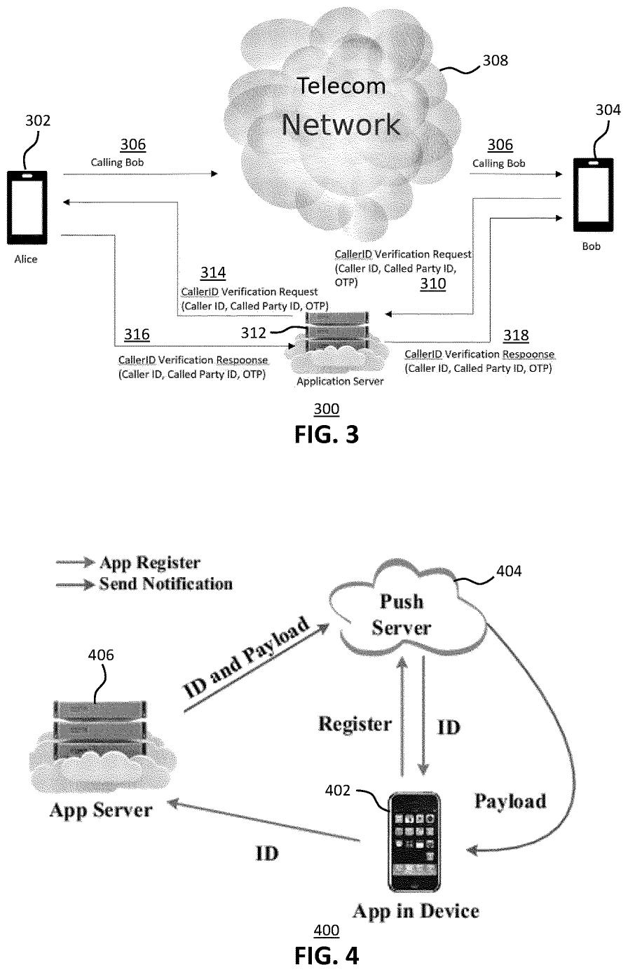

As indicated above, in a particular example, a calling party is referred to as A (Alice) and a called party is referred to as B (Bob). When B (Bob) receives a call or a request for a call that identifies A (Alice) as the calling party, in some examples, an application of Bob's device generates a One-Time-Password (OTP) and sends it out-of-band to A (Alice). This is illustrated in FIG. 3, which shows an example of a system 300 in which examples of this disclosure may be implemented. The system 300 includes Alice 302 and Bob 304. Alice 302 sends a call request 306 to Bob 304 via a telecoms network 308 on a first channel, which may be for example a landline network, mobile network, and/or any other network.

When the application on the device of Alice 302 receives the OTP, it sends it back to Bob 304, or a different value derived from the OTP. Once the application on Bob's device receives the OTP (or value derived from it) and confirms that it is the OTP it generated and sent to Alice 302, it may be determined or concluded that Alice 302 was the originator of the call. Thus, in some examples, appropriate action may be taken, e.g. Bob 304 may receive a notification that the caller ID h as been verified, the call may be accepted or allowed to continue, etc.

The OTP is sent on a second channel, out of band (that is, for example, without using the same channel or communication method as the call request or call). This may be done in a number of suitable ways, and some examples are illustrated.

In the example shown in FIG. 3, Bob 304 sends a CallerID Verification Request 310 to an application server 312. The application server may then send a CallerID Verification Request 314 to Alice 302 (e.g. an application on Alice's device). The verification requests may identify the caller ID, the called party ID (e.g. the ID of Bob or Bob's device) and the OTP. Alice (assuming that Alice originated the call) sends a reply, a CallerID Verification Response 316, to the application server 312, which sends a CallerID Verification Response 318 to Bob 304 (e.g. an application on Bob's device). The verification response may identify the caller ID, the Called party ID, and the OTP (or a value derived from or based on the OTP).

In some examples, the verification request and/or the reply may be sent using push notifications. Mobile push notifications are small, pop-up messages that can appear on a mobile device even when a user isn't actively using an app. They are sent using a push notification service. Mobile platforms, such as iOS and Android, have their own push notification service. Commercial push notification services are similar in their architectural design, as shown in FIG. 4, which shows an example of such an architectural design 400. When an application launches in a mobile device 402, it needs to register to the push service with a push server 404 to get a unique ID (it may have different names in different platforms, e.g., device token in iOS and push URI in Windows), and then send the unique ID to an application server 406. When the application server 406 wants to send a push notification to an application on the mobile device 402, it sends the ID together with the payload to the push server 404, which then forwards the payload to the application.

In some examples of this disclosure, both the calling party and the called party have an application (e.g. a CIOV application) installed on their devices, which registers the subscription (e.g. MSISDN) with a Push Notification Service (deployed in the Cloud) and handles the verification of the caller ID as described below. When a call is received (e.g. by Bob), the application sends an OTP over the internet to the calling party using the push notification service. The caller ID may also be presented on the screen of the called party's device. It is important that the calling party has the application and has been registered in a push notification service and has been successfully authenticated by that service. The OTP can then reach the calling party via the push notification server in a verification request, with the intervention of the application server in the Cloud. When the application on the Calling party's device receives the OTP (and Bob's caller ID in some examples), it verifies that there is really was call to Bob by Alice and sends back the OTP in a reply to the verification request. The reply to the follows the reverse logical path and reaches eventually the device of the called party, where the OTPs are compared (i.e. the sent OTP is compared to the received OTP). Once the OTP is verified, Bob's device may for example notify the user that the caller ID has been verified by the CIOV service.

Other ways to transfer the OTP to the calling party include Viber®, Messenger® or any other instant messaging service (IMS) that has an API and could be integrated with the application. The instant messaging service may also provide end to end encryption in some examples.

In case there is no internet access to either the calling party or the called party, or in other examples, the SMS service may be used. In this solution, the application on the called party's device sends a verification request as an SMS message to the calling party, including the OTP generated by the application. Once the application on the called party's device receives the SMS message, if it originated the call or call request, it sends a short message back to the called party, including the same OTP (or a value based on it). This may for example be used as a fallback solution where internet access is unavailable for the push notification service, or the push notification service itself is unavailable.

Some operators could in some examples choose to deploy embodiments of this disclosure in a network node instead of a user's device. Thus, for example, a network node between the calling party and the called party may perform the method 100 shown in FIG. 1. For example, this may be implemented in a terminating network segment and may ensure that called parties receive only calls that have been successfully verified.

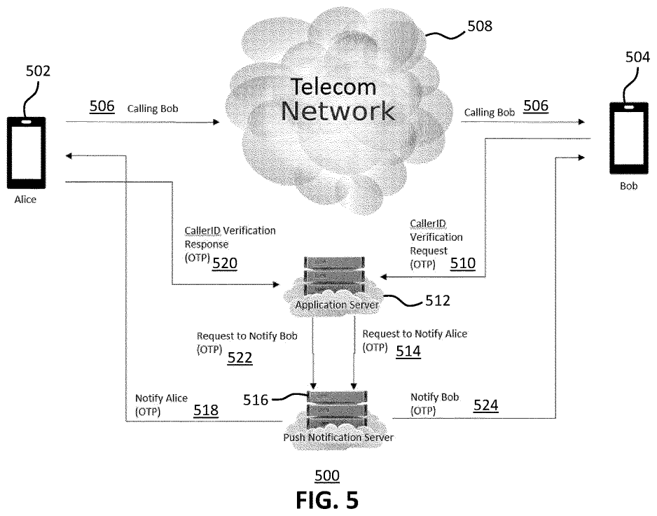

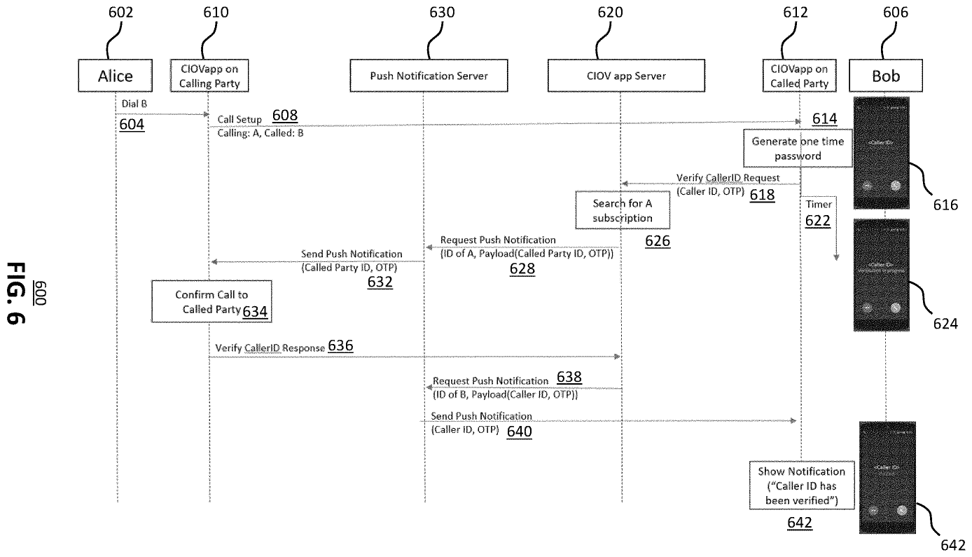

FIG. 5 shows another example of a system 500 in which examples of this disclosure may be implemented. In this example, push notifications are used. The system 500 includes Alice 502 and Bob 504. Alice 502 sends a call request 506 to Bob 504 via a telecoms network 508 on a first channel, which may be for example a landline network, mobile network, and/or any other network. Bob 504 sends a CallerID Verification Request 510 to an application server 512. The application server 512 may then send a CallerID Verification Request 514 to a push notification server 516. The push notification server 516 sends a push notification 518 to Alice 502 including the OTP (or a value based on it). If Alice 502 originated the call request 506, Alice sends a CallerID Verification Response push notification request 520 including the OTP/value to the application server 512, which sends a request 522 to send the push notification including the OTP/value to the push notification server 516. The push notification server 516 then sends a push notification 524 to Bob 504 including the OTP or value. Bob 504 can then compare the original OTP with the OTP or value in the push notification 524 to determine whether the call came from Alice 502.

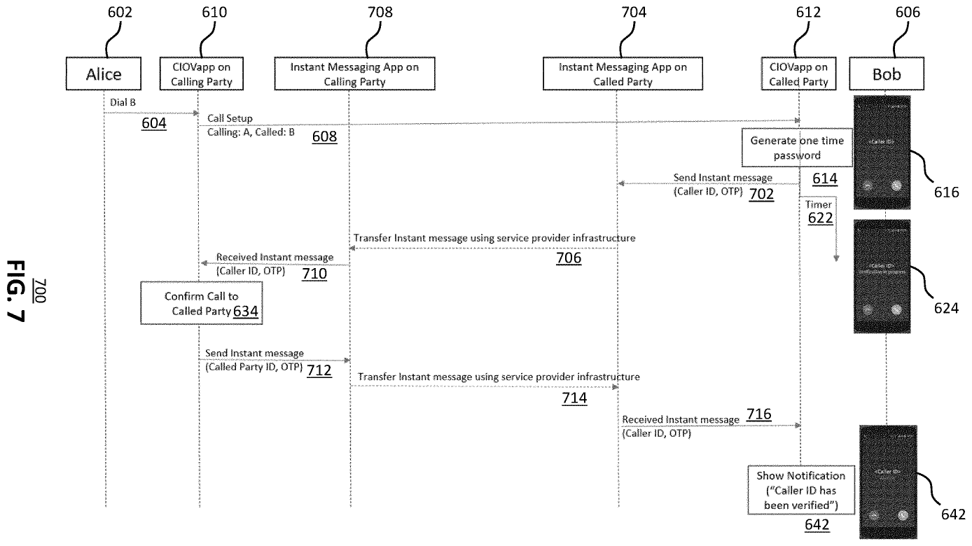

FIG. 6 shows an example of communications in an example method 600 of verifying a calling party. The method 600 includes the following steps and communications.
Step 602: Alice 604 dials a call 604 to Bob 606.
Step 608: An application on Alice's device (referred to as CIOVapp on Caller 610) forwards a call request 608 to an application (referred to as CIOVapp on Called party 612) on Bob's device.
Step 614: the application 612 on Bob's device generates an OTP. Bob's device may also display a notification 616 that there is an incoming call and that the caller ID has not (or has not yet) been verified.
Step 618: The application 612 on Bob's device sends a CallerID Verification Request 618 to an application server 620 including the OTP and Alice's caller ID. This may also include Bob's called party ID in some examples. A timer 622 may also be started, and Bob's device may also display a notification 624 that caller ID verification is in progress.
Step 626: The application server 620 searches for a subscription that corresponds to the caller ID in the verification request 618.
Step 628: If a subscription is found, the application server 626 sends a push notification request 628 to the push notification server 630 including the ID of Alice 602 (e.g. the push notification ID), and a payload including the OTP and the called party ID.
Step 632: The push notification server 630 sends a push notification 632 to the application 610 on Alice's device, including the called party ID and OTP.
Step 634: The application 610 determines whether a call was made to the called party ID by Alice 602.
Step 636: If Alice 602 did make the call, then the application 610 sends a Verify CallerID Response push notification request 636 including the OTP (or a value based on it) to the application server 620. This may also include Alice's caller ID in some examples.
Step 638: The application server 620 sends a Request Push Notification 638 including Bob's push notification ID, the caller ID, and the OTP to the push notification server 630.
Step 640: The push notification server 630 sends a push notification 640 to the application 612 on Bob's device including the caller ID and OTP/value.
Step 642: If the received OTP (or value) matches the originally sent OTP in step 618, Bob's device may display a notification that the caller ID has been verified.

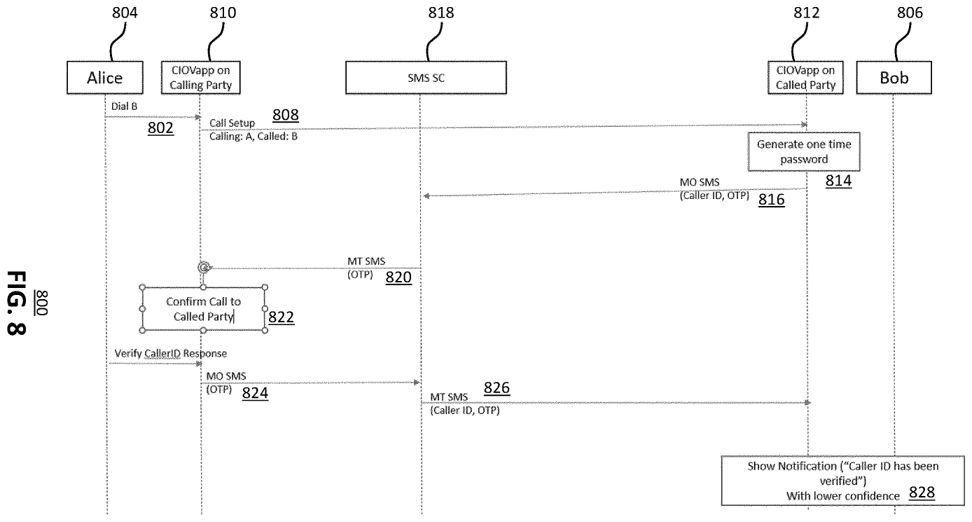

FIG. 7 shows another example of communications in an example method 700 of verifying a calling party. In this example, an Instant Messaging Service (IMS) is used to verify the calling party. In this example, steps 604, 608, 614, 616, 622, 624, 634 and 624 are the same as described above for the method 600 of FIG. 6. Following step 614, however, in the method 700 of FIG. 7, the application 612 on Bob's device sends a request 702 to an instant messaging application 704 on Bob's device to send an instant message to Alice 602 including the caller ID and OTP. Next, the instant messaging application 704 sends an instant message 706 to an instant messaging application 708 on Alice's device. This may in some examples be sent via the instant message service provider's infrastructure. This instant message 706 may also include the caller ID and OTP.

Next, the instant messaging application 708 on Alice's device forwards the instant message (or at least the caller ID and OTP) 710 to the application 610. The application 610 may then in step 634 determine whether a call was made to the called party ID by Alice 602. If so, the application 610 sends a request 712 to the instant messaging application 708 to send an instant message to Bob 604 including the called party ID and OTP (or value based on it).

The instant messaging application 708 sends the instant message 714 to the instant messaging application 704 on Bob's device, and this may also go via the service provider's infrastructure in some examples, and may include the called party ID and OTP/value. Bob's instant messaging app 708 forwards the instant message (or at least the caller ID and OTP/value) 716 to the application 612. Next, if the received OTP (or value) matches the originally sent OTP in step 618, Bob's device may display a notification 642 that the caller ID has been verified.

FIG. 8 shows another example of communications in an example method 800 of verifying a calling party. The method 800 includes the following steps and communications.
Step 802: Alice 804 dials a call to Bob 806.
Step 808: An application on Alice's device (referred to as CIOVapp on Calling party 810) forwards a call request 808 to an application (referred to as CIOVapp on Called party 812) on Bob's device.
Step 814: the application 812 on Bob's device generates an OTP. Bob's device may also display a notification that there is an incoming call and that the caller ID has not (or has not yet) been verified.
Step 816: The application 812 on Bob's device sends an SMS message to a SMS service center (SMS SC) 818. A timer may also be started, and Bob's device may also display a notification that caller ID verification is in progress.
Step 820: The SMS SC forwards the SMS message 820 to the application 810 on Alice's device.
Step 822: The application 810 determines whether a call was made to the called party ID by Alice 804.
Step 824: If Alice 804 did make the call, then the application 810 sends an SMS message 824 to the SMS SC 818 including the OTP (or a value based on it) to the application server 620. This may also include Alice's and/or Bob's caller ID in some examples.
Step 826: The SMS SC forwards the SMS message 826 to the application 812 on Bob's device.
Step 828: If the received OTP (or value) in the SMS message 826 matches the originally sent OTP in step 618, Bob's device may display a notification that the caller ID has been verified.

In some examples that use SMS messaging, this could be used as a fallback option from other options (e.g. using push notifications or IMS messaging) in case the called party device does not have internet access. The verification procedure may be slower using SMS in some examples, but if it is done while the call has been answered, it will not impact the user's experience.

In some examples of this disclosure, the called party (e.g. Bob) may be kept informed about the verification status of the caller ID. For example, one or more of the following actions may be performed:
When a call or call request is received, there shall be a message on the called party's device informing the user that the caller ID has not (or has not yet) been verified.
Once the verification process is started, the message will tell the user that verification is ongoing.
If the verification process cannot be started, there will be a message saying the caller ID cannot be verified.
If the verification process fails (e.g. timer timeout), the message will inform the user that the verification process failed.
If the verification process is completed and the OTP or value is correct, the message will indicate that the caller ID has been verified.
If the verification process is completed and the OTP is not correct, the message will say that the caller ID may be spoofed.

There are several scenarios where the verification procedure will be unsuccessful. For example:
The procedure may in some examples be supervised by a timer which will be started on the Called party device once a call or call request is received, or when the verification request is sent.
If the service that takes the responsibility to transfer the OTP to the Calling party (e.g. push notification service, IMS or SMS) cannot achieve this, e.g. service unavailable or no internet access, the verification procedure may terminate and the Called party may be informed accordingly.
When the Calling party receives the OTP, but it does not verify that there is an ongoing call to the Called party, the calling party (or the calling party's application or device) may in some examples respond back to the called party with the same OTP (or derived value), but with an indication that no call to B is ongoing. Alternatively, the OTP may for example omit the OTP, return a deliberately incorrect OTP or value, or simply ignore the verification request.
In any case, the verification procedure may be terminated in the called party's device or application on expiry of the timer if no reply to the verification request is received in that time.

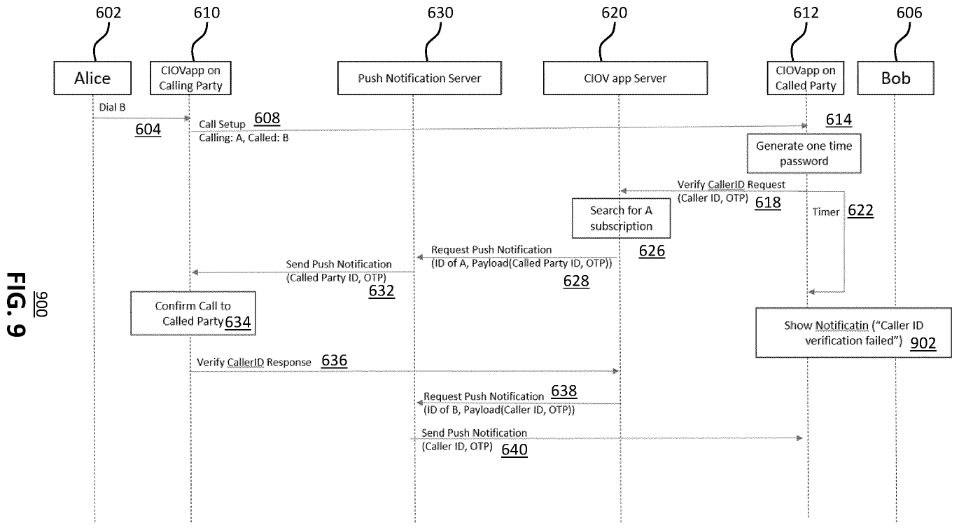

FIG. 9 shows another example of communications in an example method of verifying a calling party where the verification fails, due to the timer expiring. Steps 604-640 of the method 900 are the same as in the method 600 described above with reference to FIG. 6. However, in step 902, before the push notification 640 is received by Bob 606 including the OTP/value from Alice 604, the timer times out. At this point, in this example, a notification is presented to Bob to indicate that the caller ID verification process has failed.

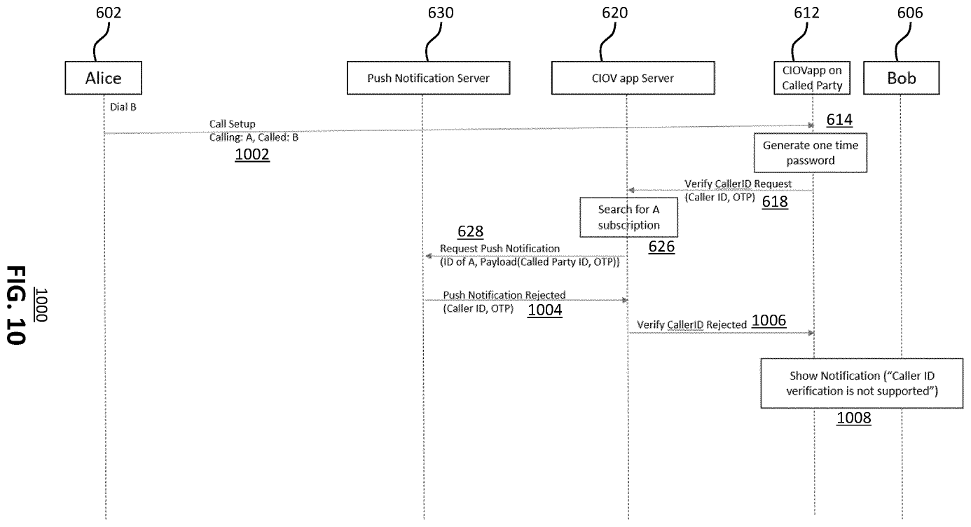

FIG. 10 shows another example of communications in an example method 1000 of verifying a calling party where the verification fails, due to Alice not supporting caller ID verification. For example, Alice's device may not have the application 610 or 810 installed. In step 1002, Alice calls Bob's caller ID. This does not happen via the application on Alice's device as in the methods described above. Steps 614, 618, 626 and 628 are the same as for the method 600 described above. However, Alice is not registered with the push notification server 620 (e.g. the appropriate application is not registered with the push notification server), and hence a push notification cannot be sent to Alice's device by the push notification server 630. Therefore, the push notification server 630 informs the application server 620 in step 1004 that the push notification request 628 is rejected. The application server 620 then indicates 1006 to the application 612 on Bob's device that the verification request is rejected, and in step 1008 a notification may be displayed to Bob that the notification process failed, for example by indicating that Alice does not support caller ID verification.

In some examples the use of out of band verification requests and that the verification is performed in the opposite direction to the call or call request (i.e. it addresses the device to which the caller ID has been registered) may assure that the request for verification reaches the owner of the caller ID. This could be compromised for example if an attacker manages to register a caller ID as their own with a verification service (e.g. push notification service or instant messaging service, or any other possible solution). However, this is considered to be very improbable.

In some examples, security is maintained as long as the spoofer cannot spoof the out of band verification response messages that the calling party sends to the called party, and at the same time sniff or guess the OTP sent by the called party. The former may be possible, but the latter may require that the attacker has compromised the service that is used to transfer the OTP. This is considered improbable in the case of a service that provides end-to-end encryption, like a push notification service over secure transport layer or an instant messaging service such as Viber. The use of SMS may be considered to be less secure, but still may be advantageous as compared to not having an additional mechanism that verifies the caller ID.

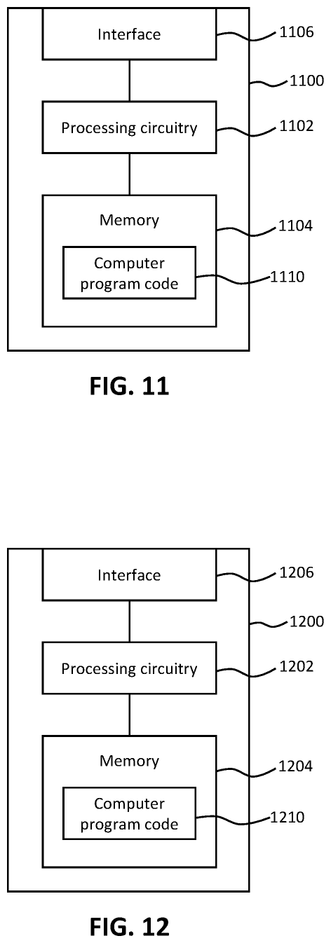

FIG. 11 is a schematic of an example of an apparatus 1100 for verifying a calling party. The apparatus 1100 comprises processing circuitry 1102 (e.g. one or more processors) and a memory 1104 in communication with the processing circuitry 1102. The memory 1104 contains instructions, such as computer program code 1110, executable by the processing circuitry 1102. The apparatus 1100 also comprises an interface 1106 in communication with the processing circuitry 1102. Although the interface 1106, processing circuitry 1102 and memory 1104 are shown connected in series, these may alternatively be interconnected in any other way, for example via a bus.

In one embodiment, the memory 1104 contains instructions executable by the processing circuitry 1102 such that the apparatus 1100 is operable/configured to receive, on a first communication channel, a call request, the call request identifying a calling party; send, to the calling party on a second communication channel different from the first communication channel, a verification request that the calling party is an originator of the call request, the verification request identifying a first value; and if a reply to the verification request is received from the calling party indicating that the calling party is the originator of the call request, and the reply identifies a second value based on the first value, determine that the calling party is the originator of the call request. In some examples, the apparatus 1100 is operable/configured to carry out the method 100 described above with reference to FIG. 1.

FIG. 12 is a schematic of an example of an apparatus 1200 for verifying a calling party. The apparatus 1200 comprises processing circuitry 1202 (e.g. one or more processors) and a memory 1204 in communication with the processing circuitry 1202. The memory 1204 contains instructions, such as computer program code 1210, executable by the processing circuitry 1202. The apparatus 1200 also comprises an interface 1206 in communication with the processing circuitry 1202. Although the interface 1206, processing circuitry 1202 and memory 1204 are shown connected in series, these may alternatively be interconnected in any other way, for example via a bus.

In one embodiment, the memory 1204 contains instructions executable by the processing circuitry 1202 such that the apparatus 1200 is operable/configured to receive, on a second communication channel different from a first communication channel for calls and/or requests for calls, a verification request that a calling party is an originator of the call request, the verification request identifying a first value; and if the calling party is the originator of the call request, send a reply to a sender of the verification request indicating that the calling party is the originator of the call request, the reply identifying a second value based on the first value. In some examples, the apparatus 1200 is operable/configured to carry out the method 200 described above with reference to FIG. 2.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e., the first or second of such features to occur in time or space) unless explicitly stated otherwise. Steps in the methods disclosed herein may be carried out in any order unless expressly otherwise stated. Any reference signs in the statements shall not be construed so as to limit their scope.

1. A method of verifying a calling party, the method comprising:
receiving, on a first communication channel, a call request, the call request identifying a calling party;
sending, to the calling party on a second communication channel different from the first communication channel, a verification request to verify that the calling party is an originator of the call request, the verification request identifying a first value; and
if a reply to the verification request is received from the calling party indicating that the calling party is the originator of the call request, and the reply identifies a second value based on the first value, determining that the calling party is the originator of the call request.

2. The method of claim 1, wherein the first value one or both:
is a randomly or pseudorandomly generated value; and
comprises a One Time Password (OTP).

3. The method of claim 1 wherein the second value is equal to the first value.

4. The method of claim 1, wherein the reply is received on the second channel or a third channel different from the second channel.

5. The method of claim 1, wherein the call request comprises a voice call request, a video call request, a Signaling System No. 7 (SS7) message or a Session Initiation Protocol (SIP) message.

6. The method of claim 1, wherein the first channel comprises a channel for one or both calls and call requests.

7. The method of claim 1, wherein the second channel comprises one or more of:
a network different from a network of the first channel;
the internet;
a channel for push notifications;
a channel for an Instant Messaging Service (IMS);
a channel for a Short Messaging Service (SMS).

8. The method of claim 1, comprising determining that the calling party is not or may not be the originator of the call request if:
a timer started on receiving the call request times out;
the reply from the calling party does not identify the first value or the second value; or
a reply is received from the calling party indicating that the calling party is not the originator of the call request.

9. The method of claim 8, comprising, on determining that the calling party is not or may not be the originator of the call request one or more of:
rejecting or blocking the call request;
terminating the call; and
sending or displaying to a called party for the call a notification that the calling party is not or may not be the originator of the call request.

10.-17. (canceled)

18. A method of verifying a calling party the method comprising:
receiving, on a second communication channel different from a first communication channel for one or both calls and requests for calls, a verification request to verify that a calling party is an originator of the call request, the verification request identifying a first value; and
if the calling party is the originator of the call request, sending a reply to a sender of the verification request indicating that the calling party is the originator of the call request, the reply identifying a second value based on the first value.

19. The method of claim 18, wherein the first value one or both:
is a randomly or pseudorandomly generated value; and
comprises a One Time Password (OTP).

20. The method of claim 18, wherein the second value is equal to the first value.

21. The method of claim 18, wherein the reply is sent on the second channel or a third channel different from the first channel.

22. The method of claim 18, wherein the call request comprises a Signaling System No. 7 (SS7) message or a Session Initiation Protocol (SIP) message.

23. The method of claim 18, wherein the second channel comprises one or more of:
a network different from a network of the first channel;
the internet;
a channel for push notifications;
a channel for an Instant Messaging Service (IMS);
a channel for a Short Messaging Service (SMS).

24. The method of claim 18, comprising, if the calling party is not the originator of the call request sending a reply to a sender of the verification request, indicating that the source device is not the originator of the call request.

25. The method of claim 18, wherein the verification request identifies one or both of the calling party and a subscriber ID of the calling party.

26. The method of claim 18, wherein the verification request comprises one or more from a group consisting of:
a push notification;
a Short Messaging Service (SMS) message; and
an Instant Messaging Service (IMS) message.

27.-34. (canceled)

35. An apparatus for verifying a calling party, the apparatus comprising a processor and a memory the memory containing instructions executable by the processor such that the apparatus is operable to:
receive, on a first communication channel, a call request, the call request identifying a calling party;
send, to the calling party on a second communication channel different from the first communication channel, a verification request that the calling party is an originator of the call request, the verification request identifying a first value; and
if a reply to the verification request is received from the calling party indicating that the calling party is the originator of the call request, and the reply identifies a second value based on the first value, determine that the calling party is the originator of the call request.

36.-51. (canceled)

52. An apparatus for verifying a calling party, the apparatus comprising a processor and a memory, the memory containing instructions executable by the processor such that the apparatus is operable to:
receive, on a second communication channel different from a first communication channel for one or both calls and requests for calls, a verification request that a calling party is an originator of the call request, the verification request identifying a first value; and
if the calling party is the originator of the call request, send a reply to a sender of the verification request indicating that the calling party is the originator of the call request, the reply identifying a second value based on the first value.

53.-75. (canceled)
